(19) United States
(12) Patent Application Publication
(10) Pub. No.: US 2012/0318468 A1
(43) Pub. Date: Dec. 20, 2012

(54) LIGHTWEIGHT REINFORCED ROLL-UP DOOR PANELS

(76) Inventor: Mark J. Szczygielski, Akron, NY (US)

(21) Appl. No.: 13/159,605

(22) Filed: Jun. 14, 2011

(51) Int. Cl. E06B 3/44

(52) U.S. Cl. 160/323.1; 160/238

(57) ABSTRACT

This invention provides improved lightweight reinforced roll-up door panels (20) The improvement includes: the panel being formed of an extruded plastic material, such as EX75 Resin ABS, and having upper and lower longitudinal edges (25, 31); the panel having an outer skin (22) and an inner skin (22) spaced from said outer skin; at least one pocket (24) positioned between the skins; and an insert (28) positioned within the pocket. The insert is so configured and arranged as to resist flexural deformation of said panel.

### TECHNICAL FIELD

The present invention relates generally to roll-up doors, and, more particularly, to improved lightweight reinforced roll-up door panels for use in such doors.

### BACKGROUND ART

Roll-up doors are ubiquitous. They are commonly found in residential garages, in industrial buildings, and in the cargo body opening of trucks and trailers.

Generally, such roll-up doors have a pair of facing inverted L-shaped tracks. Lower portions of the tracks are generally vertical, intermediate portions are generally curved or arcuate, and upper portions are generally horizontal. The various door panels are connected via a plurality of hinges. Some of the outboard hinges (i.e., those adjacent the tracks) have rollers mounted in the tracks for guided movement therealong. Thus, the door may be selectively lowered to a vertical position to close the access opening, or selectively moved upwardly to an overhead out-of-the-way horizontal position to allow ingress and egress through the access opening.

Modern door panels are extruded of suitable plastic materials. However, it would be generally desirable to provide improved plastic door panels that resist torsional and flexural deformation of the panel. Such deformation may occur, for example, by a shifting load that strikes a closed door, or simply by the weight of the panel when the door is in its overhead out-of-the-way position.

### DISCLOSURE OF THE INVENTION

With parenthetical reference to the corresponding parts, portions or surfaces of the disclosed embodiments, merely for purposes of illustration and not by way of limitation, the present invention provides improved lightweight reinforced panels (20) for use in roll-up doors and other structures, wherein the improvement comprises: the panel being formed of an extruded plastic material, and having upper and lower longitudinal edges (25, 31); the panel having an outer skin (22) and an inner skin (21) spaced from the outer skin; at least one longitudinally-extending pocket (24) positioned between the skins; and an insert (28) positioned within the pocket; and wherein the insert is so configured and arranged as to resist flexural deformation of the panel.

The panel may, for example, be formed of a suitable ABS plastic material, such as EX75 Resin ABS, available from SABIC Innovative Plastics, One Plastics Ave., Pittsfield, Mass. 01201. However, this example is not limitative of other possible materials that may be substituted for such material.

The outer skin may, for example, be covered with a top coat material, such as Geloy XTW Resin, also available from SABIC Innovative Plastics, supra. Here again, this example is not limitative of other possible materials that may be substituted for such material. The top coat material may have many benefits, such as gloss and color retention, mechanical performance retention, chemical resistance, scratch resistance, and excellent adhesion to ABS or PVC plastic materials.

The improvement may further include at least one web (23) extending between the skins. The insert and panel construction retards thermal expansion and contraction of the panels.

A pocket may be positioned between the skins adjacent one longitudinal edge of the panel.

The pocket may be a first pocket (24A), and the improvement may further include a second pocket (24G) extending between the skins adjacent the other longitudinal edge of the panel.

The insert may be a first insert (28A) and is positioned in the first pocket, and the improvement may further include a second insert (28E) positioned in the second pocket.

The insert may have a C-shaped transverse cross-section (e.g., 28H in FIG. 2; 28B in FIG. 5, etc.), a tubular transverse cross-section (e.g., 28A in FIG. 1), a rectangular tubular transverse cross-section (e.g., 28A in FIG. 1), a solid transverse cross-section (e.g., 24A in FIG. 5A; 44 in FIG. 9A), or some other transverse cross-section.

The insert is preferably so dimensioned and proportioned that the insert may be slidably inserted into the pocket.

The insert(s) may be formed of a suitable steel, a suitable aluminum, a suitable alloy, a suitable galvanized material, a suitable plastic material, or some other material.

The panels and inserts are preferably so dimensioned and proportioned that a 96 inch length of the panel will not deflect more that ¼ of an inch at the midpoint of the panel when the panel is in a horizontal position. It is preferred to minimize panel deflection to facilitate smooth panel joint movement through the arcuate section of the tracts, and to improve the lives of the various hinges and fasteners.

The improvement may further include a hinge fixture (38) mounted on the inner skin; and a fastener (36) having one portion engaging the roller fixture, having an intermediate portion penetrating the roller fixture and a portion of the insert, and having another portion engaging the insert.

In some forms, the fastener (e.g., 36 in FIG. 8) does not penetrate the outer skin.

The improvement may further include a hinge (32) mounted on the inside skin.

The improvement may further include a fastener (e.g., 40 in FIG. 9) having one portion engaging the hinge, having an intermediate portion penetrating the hinge and a portion of the insert, and having another portion engaging the insert.

The fastener intermediate portion may penetrate two portions of the insert.

In some embodiments, the fastener does not penetrate the outer skin.

In other forms, the improvement further includes a block of material (e.g., 44 in FIG. 9A) arranged within the cavity and aligned with the hinge, and a fastener (40) having one portion engaging the hinge, having an intermediate portion penetrating the hinge, the inner skin, the insert, the solid material, and the outer skin, and having another portion engaging the outer skin.

The hinge may be a roller hinge, or may be some other type of hinge (e.g., a leaf hinge, a continuous hinge, etc.).

The block of material may be a block of solid plastic material. However, this is not limitative. For example, the block could be formed of wood, metal, an extrusion, a rigid foam, etc.

The block of material may extend the full longitudinal extent of the panel, or may be positioned only in the immediate vicinity of a hinge.

Accordingly, the general object of this invention is to provide an improved lightweight reinforced panels for use in roll-up doors.

### BRIEF DESCRIPTION OF THE DRAWINGS

FIG. 1 is a fragmentary transverse vertical sectional view of the upper portion of a first embodiment of an improved lightweight reinforced roll-up door panel according to the present invention.

FIG. 2 is a view generally similar to FIG. 1, but shows a second embodiment of the roll-up door panel.

FIG. 3 is a view generally similar to FIG. 2, but shows a third embodiment of the improved roll-up door panel.

FIG. 4 is a view generally similar to FIG. 3, but shows a fourth embodiment of an improved roll-up door panel.

FIG. 5 is a view generally similar to FIG. 4, but shows a fifth embodiment of an improved roll-up door panel, this embodiment showing a rectangular tubular insert the uppermost pocket of the panel.

FIG. 5A is view generally similar to FIG. 5, but shows a sixth form of the improved door panel, this view showing a solid insert in the uppermost panel pocket.

FIG. 6 is a left side elevation of the panel shown in FIG. 5, showing the inner skin of the panel in elevation.

FIG. 7 is a fragmentary transverse vertical sectional view of a seventh form of the improved door panel, showing multiple webs extending between the inner and outer skins, this view also omitting any inserts.

FIG. 8 is a fragmentary transverse vertical sectional view of marginal end portions of two adjacent panels, this view showing C-shaped inserts as being arranged in pockets of the panels adjacent the joint, with rivet-like fasteners penetrating the inner skin and the insert, but not penetrating the outer skin.

FIG. 9 is a view generally similar to FIG. 8, but showing a roller hinge mounted on the marginal end portions of two adjacent panels, this view also showing headed fasteners as passing through both skins and the C-shaped inserts.

FIG. 9A is view generally similar to FIG. 9, but shows the use of solid plastic inserts in lieu of C-shaped inserts shown in FIG. 9.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Turning now to the drawings, the present invention broadly provides improved lightweight reinforced panels for use in roll-up doors and other structures. The door may be mounted to selectively close an access opening in a building or static structure, the cargo opening of a truck or trailer, or may be mounted on some other type of structure.

### First Embodiment

### (FIG. 1)

FIG. 1 is a fragmentary transverse vertical sectional view of the upper portion of a first form on an improved door panel.

This door panel, generally indicated at 20, is shown as being an extruded member having a vertically-disposed inner skin 21, a vertically-disposed outer skin 22 spaced horizontally from the inner skin, and a plurality of vertically-spaced webs, severally indicated at 23, extending between the two skins. These skins and webs define a series of longitudinally-extending pockets. The uppermost pocket is indicated at 24A, the next lower pocket is indicated at 24B, the next lower pocket is indicated at 24C, the next lower pocket is indicated at 24D, and the lowermost pocket is indicated at 24E. The various pockets may be partially enclosed and defined by three orthogonal walls (e.g., upper pocket 24A), or may be completely enclosed and defined by four orthogonal walls (e.g., pocket 24B). The door panel is shown as having an uppermost horizontal longitudinal edge 25.

An inverted U- or channel-shaped member 26 is indicated as being positioned over the upper edge of the door panel. A seal member 30 is mounted on a U-shaped member 26.

A metallic rectangular tubular insert 28A is slidably inserted into the uppermost pocket 24A, and is secured in the position by a headed fastener, generally indicated at 29. Another insert 28B is slidably inserted into pocket 24B, and a third insert 28D is slidably inserted into 24D. These last two inserts, 28B and 28D, may simply be slidably inserted into their associated pockets. These may be retained in the illustrated positions by means of suitable ends (not shown) mounted on the panel.

A top coat material 27, such as Geloy XTW Resin, supra, is applied to the leftward or outer surface of the outer skin. The top coat may possibly have a homogeneous color with a base. This will minimize scratch detection.

### Second Embodiment

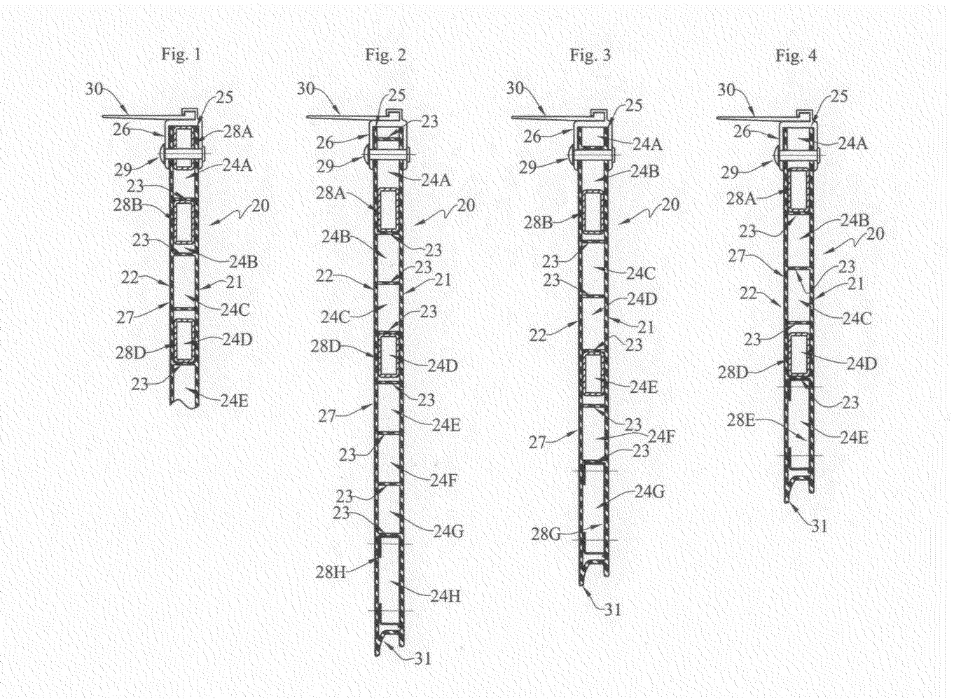

### (FIG. 2)

FIG. 2 is a fragmentary transverse vertical sectional view of a second embodiment of the improved panel.

This panel, again indicated at 20, is also shown as having a vertically-disposed inner skin 21, a vertically-disposed outer skin 22 spaced horizontally form the inner skin, and a plurality of vertically-spaced webs, severally indicated at 23, extending between the two skins, and vertically-spaced forming a series of longitudinally-extending pockets, indicated at 24A-24H, respectively. These pockets may extend the full longitudinal extent of the panel, or may extend inwardly from a panel edge for less than the full longitudinal extent of the panel.

The upper longitudinal edge 25 of this panel is closed by an inverted U-shaped member 26, which contains a top seal 30. Member 26 is secured to the upper portion of the panel by means of a horizontal fastener 29.

Three inserts are shown as having been slidably inserted longitudinally into the panel. The first of these inserts 28A is shown as being positioned in pocket 24A, the second insert 28D is shown as being positioned in pocket 24D, and the third insert 28H is shown as being positioned in lowermost pocket 24H adjacent panel lower edge 31. The upper two inserts are shown as being rectangular tubular members, preferably formed of aluminum, stainless steel, galvanized steel or some other alloy. The lowermost insert 28H is shown as being a C-shaped member. Here again, each of these inserts is slidably and longitudinally inserted into its associated pocket. The other pockets are empty.

A top coat material 27, such as Geloy STW Resin, supra, is applied to the leftward or outer surface of the outer skin.

### Third Embodiment

### (FIG. 3)

FIG. 3 is a fragmentary transverse vertical section view of a third form of the improved door panel.

Here again, the door panel is shown as being formed of a suitable extruded plastic material, such as EX75 Resin ABS, supra. The panel, again indicated at 20, is shown as having a vertically-disposed inner skin 21, a vertically-disposed outer skin 22 spaced horizontally from the inner skin, and a plurality of vertically-spaced webs, severally indicated at 23, extending therebetween, and forming a series of pockets, indicated at 24A-24G, respectively.

The upper edge 25 of the panel is closed by an inverted U-shaped member 26, which is secured to the panel by means of a headed fastener 29. Seal member 30 is mounted on member 26.

In this form, three inserts are slidably inserted into various pockets. The first insert 28B is positioned in pocket 24A, the second insert 28E is inserted into pocket 24E, and the third insert 28G is inserted into lowermost pocket 24G. The two upper inserts, 28B and 28E, are shown as being rectangular hollow tubular members. The lowermost insert 28G is shown as being a C-shaped member.

A top coat material 27, such as Geloy STW Resin, supra, is applied to the leftward or outer surface of the outer skin.

### Fourth Embodiment

### (FIG. 4)

FIG. 4 is a fragmentary transverse vertical sectional view of a fourth embodiment of the improved panel.

The panel is again indicated at 20, and is shown as having horizontally-spaced vertically-disposed inner and outer skins, 21, 22, respectively, separated by a plurality of vertically-spaced webs, severally indicated at 23. These webs divide the area between the skins into a series of pockets, indicated at 24A-24E, respectively.

The upper longitudinal edge 25 of this panel is closed by an inverted U-shaped member 26, which is secured to the upper marginal end portion of the panel by means of a fastener 29. Member 26 also supports a top seal 30.

In this form, three inserts are slidably inserted longitudinally into the panel from one or both ends thereof. The first insert 28A is positioned in pocket 24A, the second insert 28D is positioned in pocket 24D, and the third insert 28E is positioned in lowermost pocket 24E. Here again, the upper two inserts, 28A and 28D, are hollow rectangular tubular members, and the lowermost insert 28E is a C-shaped member.

A top coat material 27, such as Geloy STW Resin, supra, is applied to the leftward or outer surface of the outer skin.

### Fifth Embodiment

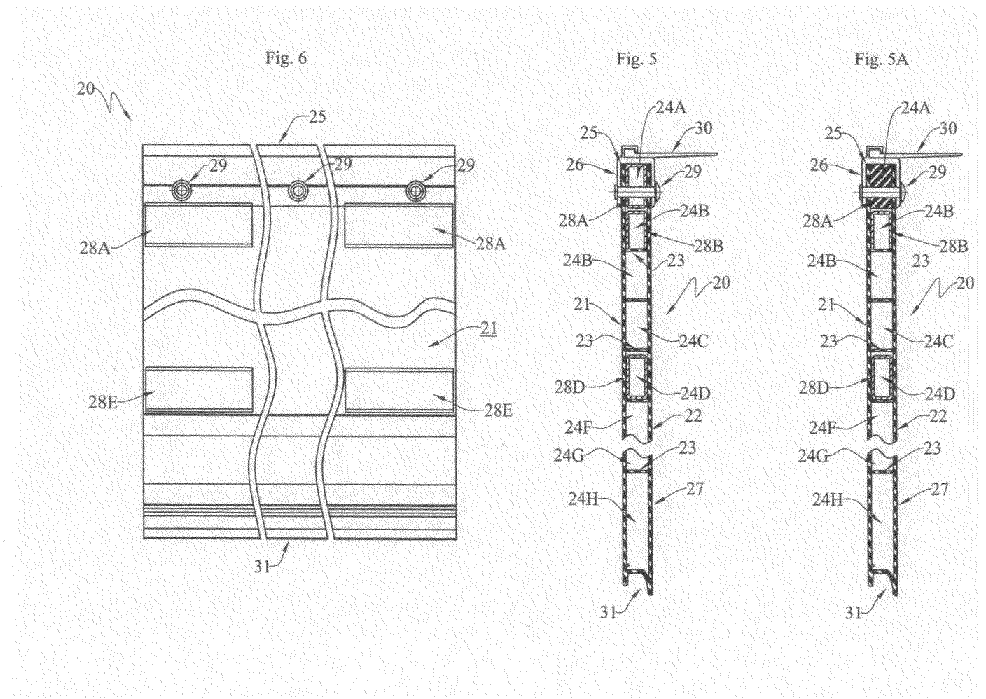

### (FIG. 5)

FIG. 5 is a fragmentary transverse vertical sectional view of a fifth form of the improved panel.

Here again, the panel is an extruded plastic member having a vertically-disposed inner skin 21, a vertically-disposed outer skin 22 spaced horizontally from the inner skin, and a plurality of vertically-spaced longitudinally-extending webs, severally indicated at 23, extending therebetween. These webs define between the inner and outer skins, a series of longitudinally-extending pockets, indicated at 24A-24H, respectively.

In this form, three inserts and slidably inserted into various pockets of the panel. The uppermost insert 28A is positioned in uppermost pocket 24A, and is secured in this position by means of a fastener 29 which is used to hold member 25 about the upper edge of the panel. The second insert 28B is positioned in pocket 24B, and the third insert 28E is slidably inserted into pocket 24E. In this form, each of the inserts is a rectangular tubular member. If desired, another insert could be inserted into lowermost pocket 24H.

FIG. 6 is a fragmentary left side elevation of the door panel shown in FIG. 5. The uppermost insert may be slidably inserted into the uppermost pocket 24A, and may extend the full width of the door if desired. In this form, the next-lower insert 24B, is slidably inserted from a panel edge, but does not extend the full width of the door. Rather, insert 24B extends only so far into the panel as may be necessary to support a roller hinge or the like. The same is true of next lower insert 28E. Note also that inserts 28B and 28E may be inserted from either vertical edge of the door. They may be used in immediate vicinity of a roller hinge, but need not necessarily extend the full width of the door because to do so would add unnecessary weight to the door.

### Sixth Embodiment

### (FIG. 5A)

FIG. 5a is a fragmentary transverse vertical sectional view of a sixth form of the improved door.

It is similar to the door shown in FIG. 5. Here again, the same reference numerals have been used to identify corresponding structure previously described. The salient difference between the panel in FIG. 5A and the panel in FIG. 5 is that the uppermost insert 28A, which is received in uppermost pocket 24A, is shown as being formed of a solid plastic material, rather than a tubular metallic material. The use of such a solid insert is deemed particularly advantageous when it is desired to provide sufficient strength to prevent crushing when the fastener 29 is applied. The insert ties the inner and outer skins together, creating a sandwich-like structure that increases stiffness and durability.

A top coat material 27, such as Geloy STW Resin, supra, is applied to the leftward or outer surface of the outer skin.

### Seventh Embodiment

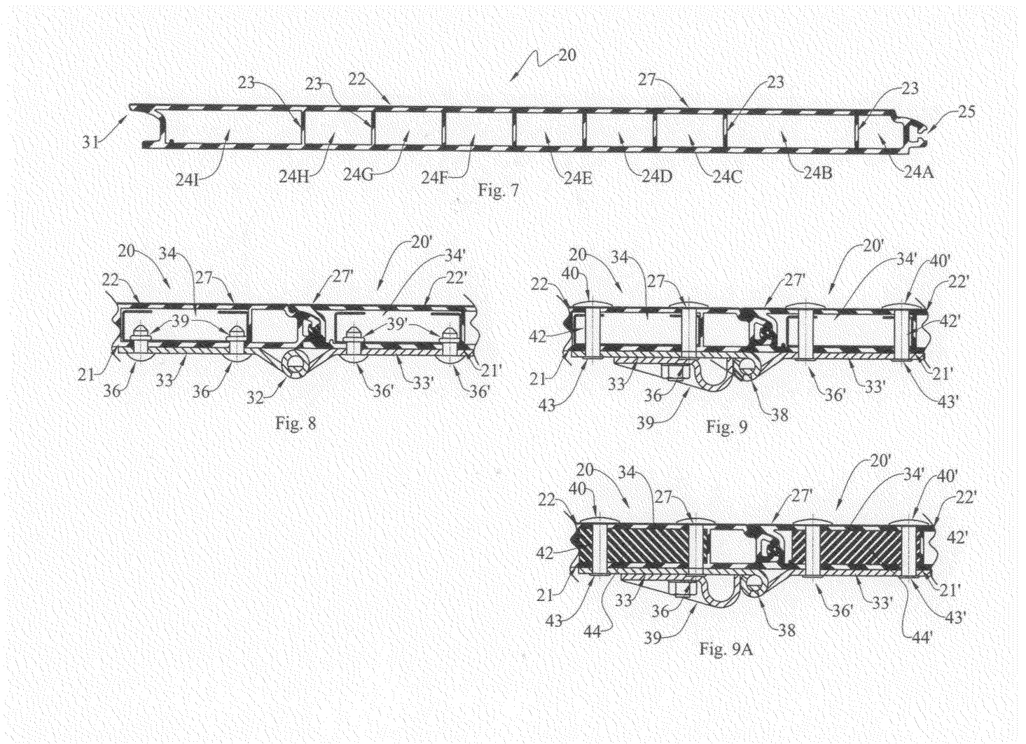

### (FIG. 7)

FIG. 7 is a fragmentary transverse vertical sectional view of a seventh embodiment of the improved panel. However, in this figure, the panel is shown as being horizontally arranged, rather than being vertically arranged.

Here again, the panel is shown as being an extruded member formed of a suitable plastic, such as EX75 Resin ABS, supra. The panel has spaced inner and outer horizontally-disposed skins 21, 22, respectively and a plurality of horizontally-spaced webs, severally indicated at 23, extending therebetween. These webs define with the skins, a series of pockets, which are severally indicated at 24A-24J, respectively. The panel has longitudinally-extending right and left edges 25, 31, respectively

A top coat material 27, such as Geloy STW Resin, supra, is applied to the leftward or outer surface of the outer skin.

### Hinge Attachment (FIG. 8)

FIG. 8 is a fragmentary transverse vertical sectional view showing the marginal end portions of two adjacent panels 20, 20′ being connected by a hinge 32.

The hinge has one section 33 mounted on the inside skin of panel 20, and has another section 33′ mounted on adjacent panel 20′. These panels are as previously described in that they have inner skins 21, 21′, and outer skins 22, 22′. Each panel has a plurality of webs 23, 23′, respectively. Each panel is shown as having a pocket adjacent the other panel. Thus, panel 20 has a pocket 34 and panel 20′ has a pocket 34′. C-shaped metallic inserts 35, 35′, are inserted into pockets 34, 34′.

A number of rivet-like fasteners, severally indicated at 36, are used to hold the assemblies together. Each rivet has a head portion 38 engaging the exposed inner surface of the hinged section, has an intermediate portion passing through the hinge section, the inner skin, and one portion of the C-shaped insert and as another portion 39 deformed to engage the insert. Two fasteners are used to secure each of the hinge sections. The arrangement shown in FIG. 8 is typically used for an interior hinge which does not have a roller. The barrel portion has a number of alternating inter-digital knuckles that fit together.

One unique feature of the arrangement shown in FIG. 8 is that no portion of the fasteners extends through the outer skin to interfere with the outer top coat 27.

### Roller Hinge Attachment (FIG. 9)

FIG. 9 is a view generally similar to FIG. 8, but shows the arrangement of a roller hinge 38 as mounted on the inside surface of a panel. Here again, FIG. 9 shows the marginal end portions of two adjacent panels. However, the salient difference is that a roller knuckle 39 is mounted on one of the panels to receive and accommodate the shaft (not shown) on which a roller (not shown) is mounted. This roller is typically received on one of the tracks on either side of the opening.

Another difference is that in the arrangement shown in FIG. 9, the fasteners extend all the way through the door. Each fastener, generally indicated at 40, has a head portion 41 engaging the outer skin, has an intermediate portion 42 passing through the outer skin, and passing twice through the C-shaped insert, and passing through the inner skin and appropriate hinge section, and terminates in a deformed portion 43 which bears against the inner hinge section. Thus, in this arrangement, the shank portion of each fastener passes twice through the appropriate insert.

### Alternative Roller Hinge Attachment (FIG. 9A)

FIG. 9A is a fragmentary transverse vertical sectional view thereof, generally similar to FIG. 9. Hence, the same reference numerals have again been used to identify structure previously described.

The salient difference here is that the inserts, indicated at 44, 44′, are shown as being solid blocks of plastic material, rather than the C-shaped metal forms shown in FIG. 8. Thus, the fasteners can be securely attached and deformed about the hinged sections, without fear of distorting the panel.

Therefore, the present invention broadly provides an improved panel for a roll-up door, wherein the improvement comprises the panel being formed of an extruded plastic material and having upper and lower longitudinal edges; the panel having an outer skin and an inner skin spaced from the outer skin; a pocket position between the skins; and at least one insert position within at least one of the pockets; and wherein the insert is so configured and arranged as to resist flexural deformation of the panel.

From the foregoing, it should be clearly understood that the improved door panels are extruded plastic members having spaced inner and outer skins, with a plurality of integrally-formed webs extending therebetween and defining with the skins a plurality of pockets. A top coat may be applied to the outer surface of the outer skin. This top coat may be Geloy XTW Resin, supra, or some other material. The general purpose of the top coat is to provide an enhanced base to receive colors or graphics applied to the outer skin. The pockets may extend the full longitudinal extent of a pane, or less than that. The insert may be C-shaped, a tubular member, a solid block of material, or may have some other shape. The insert may be formed of steel, aluminum, a suitable metal alloy, a galvanized material, a plastic material, or some other material. The purpose of the invention is to provide improved lightweight and reinforced door panels for use in roll-up door sand other structures. In a preferred embodiment, the panels and inserts are so dimensioned and proportioned that a 96 inch length of the panel will not deflect by more than about ¼ of an inch at the midpoint of the panel when the panel is supported by track-mounted rollers in a horizontal position.

### Modifications

Any of the improved panels, including any of the forms illustrated, may be formed of a suitable material, such as EX 75 Resin ABS, supra. The outer skin of any of the panels may be covered with a suitable top coat material, such as a Geloy XTW Resin, supra. However, it should be clearly understood that other types of materials may be substituted for these two materials.

While the configuration of the various panels may change, the salient feature is that an insert may be slidably inserted into at least one of the pockets so as to reinforce the panel against flexural and torsional deformation. The inserts may have C- or Z-shaped or tubular transverse cross-sections. The insert may also be formed of a tubular or C-shaped material, or may have some other multi-legged shaped, and may be formed of steel, aluminum, a suitable metal alloy, a galvanized material or the like. Alternatively, the insert may be formed of a solid material, typically a plastic. Other types of materials may be substituted for those mentioned. The particular shape, configuration and material of the each inserts is not deemed critical, and may be changed as may be needed or necessary.

Similarly, the configuration of the panels may be changed and varied to suit the particular application. They need not necessarily be formed of plastic. For example, they could be formed of aluminum, fiberglass, or some other extrudable, castable or moldable alloy.

Other types of fasteners (e.g., bolt and nut, etc.) may be readily substituted for the rivet-like fasteners shown.

Therefore, while several preferred forms of the present invention have been shown and described, and various modifications and changes thereof discussed, various additional changes and modifications may be made without departing from the spirit of the invention as defined and differentiated by the following claims.

What is claimed is:

1. A panel for a roll-up door, wherein the improvement comprises:
said panel being formed of an extruded material and having upper and lower longitudinal edges;
said panel having an outer skin and an inner skin spaced from said outer skin;
a pocket positioned between said skins; and
an insert positioned within said pocket, and
wherein said insert is so configured and arranged as to resist flexural deformation of said panel.

2. The improvement as set forth in claim 1 wherein said panel is formed of EX75 Resin ABS plastic material.

3. The improvement as set forth in claim 1 wherein said outer skin is covered with a top coat material.

4. The improvement as set forth in claim 3 wherein said top coat material is Geloy XTW Resin.

5. The improvement as set forth in claim 1, and further comprising:
at least one web extending between said skins.

6. The improvement as set forth in claim 1 wherein said pocket is positioned between said skins adjacent one longitudinal edge of said panel.

7. The improvement as set forth in claim 6 wherein said pocket is a first pocket, and wherein the improvement further comprises:
a second pocket extending between said skins adjacent the other longitudinal edge of said panel.

8. The improvement as set forth in claim 7 wherein said insert is a first insert and is positioned in said first pocket, and wherein the improvement further comprises:
a second insert positioned in said second pocket.

9. The improvement as set forth in claim 1 wherein said insert has a C-shaped transverse cross-section.

10. The improvement as set forth in claim 1 wherein said insert has a tubular trans-verse cross-section.

11. The improvement as set forth in claim 1 wherein said insert has a rectangular tubular transverse cross-section.

12. The improvement as set forth in claim 1 wherein said insert has a solid trans-verse cross-section.

13. The improvement as set forth in claim 1 wherein said insert is so dimensioned and proportioned that said insert may be slidably inserted into said pocket.

14. The improvement as set forth in claim 1 wherein said insert is formed of one of steel, aluminum, an alloy, and a galvanized material.

15. The improvement as set forth in claim 1 wherein said insert is so dimensioned and proportioned that a 96 inch length of said panel will not deflect more that ¼ of an inch at the midpoint of said panel when said panel is in a horizontal position.

16. The improvement as set forth in claim 1, and further comprising:
a roller fixture mounted on said inner skin; and
a fastener having one portion engaging said roller fixture, having an intermediate portion penetrating said roller fixture and a portion of said insert, and having another portion engaging said insert.

17. The improvement as set forth in claim 16 wherein said fastener does not penetrate said outer skin.

18. The improvement as set forth in claim 1, and further comprising:
a hinge mounted on said inside skin.

19. The improvement as set forth in claim 18, and further comprising:
a fastener having one portion engaging said hinge, having an intermediate portion penetrating said hinge and a portion of said insert, and having another portion engaging said insert.

20. The improvement as set forth in claim 19 wherein said fastener intermediate portion penetrates two portions of said insert.

21. The improvement as set forth in claim 19 wherein said fastener does not penetrate said outer skin.

22. The improvement as set forth in claim 18, and further comprising:
a block of material arranged within said cavity and aligned with said hinge, and
a fastener having one portion engaging said hinge, having an intermediate portion penetrating said hinge, said inner skin, said insert, said solid material, and said outer skin, and having another portion engaging said outer skin.

23. The improvement as set forth in claim 22 wherein said hinge is a roller hinge.

24. The improvement as set forth in claim 22 wherein said block of material is a block of solid plastic material.

25. The improvement as set forth in claim 22 wherein said block of material is only positioned in the immediate vicinity of said hinge.
